(19) United States
(12) Patent Application Publication
(10) Pub. No.: US 2012/0230069 A1
(43) Pub. Date: Sep. 13, 2012

(54) STARTUP CONTROL CIRCUIT WITH ACCELERATION STARTUP FUNCTION AND METHOD FOR OPERATING THE SAME

(76) Inventors: Ren-Huei TZENG, Taipei (TW); Ching-Hao Li, Taipei (TW); Jian-He Li, Taipei (TW)

(21) Appl. No.: 13/188,773

(22) Filed: Jul. 22, 2011

(30) Foreign Application Priority Data
Mar. 11, 2011 (TW) 100108239

(51) Int. Cl. H02M 1/00

(52) U.S. Cl. 363/49

(57) ABSTRACT

A startup control circuit with an acceleration startup function and a method for operating the same are disclosed. The startup control circuit is applied to a power supply. A power switch, which is coupled to a primary-side winding of a transformer, is switched to control the transformer, thus adjusting the output voltage of the power supply. The startup control circuit mainly includes a capacitor and a startup control apparatus. The startup control apparatus includes an enable switch unit and a power control unit. By turning on and turning off the enable switch unit of the startup control apparatus, the acceleration startup control and the stable output power of the power supply can be implemented.

### BACKGROUND OF THE INVENTION

1. Field of the Invention

The present invention relates generally to a startup control circuit and a method for operating the same, and more particularly to a startup control circuit with an acceleration startup function and a method for operating the same.

2. Description of Prior Art

A pulse-width modulation (PWM) technology is a traditional technology to control and adjust output power of the power supply. The power supply have to provide various protection functions, such as, an over voltage protection, an over current protection, an over power protection, and so on, to avoid permanent damages to the power supply itself and peripheral circuits thereof.

U.S. Pat. No. 6,587,357 disclosed an apparatus for providing integrated low power self-supply in switched mode power supplies. Referenced is made to FIG. 1A and FIG. 1B which are a functional schematic diagram of the switched-mode power supply with an integrated self-supply circuit and a waveform associated with the integrated self-supply circuit depicted in FIG. 1A, respectively. The switched-mode power supply includes a primary-side circuit 20, a secondary-side circuit 30, and a power controller 40. The power controller 40 has a controllable power source 42, a comparator 44, a capacitor 46, a controller 48, a power switch 52, and a reference voltage 56. The controller 48 receives a feedback signal from a feedback circuit 38 to control the duty cycle of the power switch 52, thus controlling the periodicity of main current flow through a primary inductive winding of the primary-side circuit 20. In addition, the reference voltage 56 is provided to compare to a voltage of an operational voltage supply line to determine the output of the comparator 44.

The operation of the switched-mode power supply is described as follows: When the power supply is initially energized, the capacitor 46 has no stored charge. Moreover, because the capacitor 46 is also connected to the operational voltage supply line 54, the voltage on the operational voltage supply line 54 will be the same as the voltage across the capacitor 46. Accordingly, the voltage magnitude of the operational voltage supply line 54 is zero. At this time, the comparator 44 outputs a high-level signal, which causes the controllable power source 42 to be electrically connected to the capacitor 46. Thus, the controllable power source 42 supplies current to charge the capacitor 46, which increases the voltage magnitude on the operational voltage supply line 54.

The voltage of operational voltage supply line 54 continues to increase to reach the second voltage magnitude. At this time, the comparator 44 outputs a low-level signal to disconnect the controllable power source 42 from the capacitor 46. Therefore, the voltage of the operational voltage supply line 54 decreases due to power that is dissipated by the various circuit components within the power controller 40, which causes the capacitor 46 to discharge. The voltage of the operational voltage supply line 54 continues to decrease to reach the first voltage magnitude. At this time, the comparator 44 outputs a high-level signal again, thus electrically connecting the controllable power source 42 to the capacitor 46. As a result, the voltage of the operational voltage supply line 54 increases, as the capacitor 46 again charges. The above-described cycle continuously repeats until power is removed from the input of the primary-side circuit 20.

Furthermore, U.S. Pat. No. 6,480,402 disclosed a startup circuit for commutation power supplies. Reference is made to FIG. 2A and FIG. 2B which are a circuit block diagram of a prior art power supply with a power controller and a waveform of voltages present in some points and of an output current of the circuit in FIG. 2A, respectively.

The power supply includes a startup circuit 40, a control integrated circuit CIC, and a transformer (not shown). The control integrated circuit CIC is also fed through a secondary side S of the transformer, and an alternate-current voltage outputted from the secondary side S is rectified by a diode D and filtered by a capacitor Cs. The startup circuit 40 has an input terminal IN connected to a feeding line La, and an output terminal OUT connected to a feeding terminal voltage Vcc of the control integrated circuit CIC and the capacitor Cs.

The startup circuit 40 further includes a first current generator 41 and a second current generator 42. The first current generator 41 supplies a current of value I and the second current generator 42 supplies a current K*I, where K is greater than or equal to 1 and preferably comprised in the interval between 5 and 10. The second current generator 42 is electrically connected to a controlled switch 44. The startup circuit 40 further has an operational amplifier 43 which has a non-inverting input to which a first prefixed voltage V3 is applied. In particular, the first prefixed voltage V3 is set to less than a turn-off voltage Voff of the control integrated circuit CIC, namely, the turn-off voltage Voff is the minimum working voltage of the control integrated circuit CIC.

An embodiment of this patent is exemplified for further demonstration. The output of the operational amplifier 43 controls the controlled switch 44. The controlled switch 44 is turned on when a voltage of the output terminal OUT is less than the first prefixed voltage V3; on the other hand, the controlled switch 44 is turned off when the voltage of the output terminal OUT is greater than or equal to the first prefixed voltage V3.

The startup circuit 40 has a first control circuit 53 for controlling a controlled switch 51. The first control circuit 53 has an operational amplifier 46 which has a non-inverting input to which a prefixed bias voltage V2 is applied, and an inverting input connected to an enable/disable terminal DIS of the startup circuit 40.

The output of the operational amplifier 46 controls the controlled switch 51. The controlled switch 51 is turned on when a voltage of the enable/disable terminal DIS is less than the prefixed bias voltage V2; on the other hand, the controlled switch 51 is turned off when the voltage of the enable/disable terminal DIS is greater than the prefixed bias voltage V2.

FIG. 2B shows a representation of the voltages present in some points and of the output current of the circuit of FIG. 2A during the normal working and in short circuit. The graph of FIG. 2B shows, starting from the top, the output current lout of the startup circuit 40, the feeding terminal voltage Vcc present at the terminals of the capacitor Cs and the enable/disable terminal voltage Vref present at the enable/disable terminal DIS. The operation of the switching power supply is described as follows: When the power supply is turned on, the controlled switch 44 and the controlled switch 51 are turned on, the current flowing from the output terminal OUT, equal to (K+1)*I, charges the capacitor Cs. When the feeding terminal voltage Vcc reaches the first prefixed voltage V3, the controlled switch 44 is turned off. At this time, the capacitor Cs is charged only by the output current lout equal to I supplied only by the first current generator 41. Accordingly, the charging voltage curve of the capacitor Cs based on the output current Tout equal to I is gradually smoother than that of the output current Tout equal to (K+1)*I. Afterward, the control integrated circuit CIC starts working when the feeding terminal voltage Vcc of the capacitor Cs reaches a start-up voltage Von of the control integrated circuit CIC. Also, the enable/disable terminal voltage Vref of the enable/disable terminal DIS rises up to the high level. Hence, the controlled switch 51 is turned off carrying toward zero the current flowing out from the output terminal OUT of the startup circuit 40. In addition, the feeding terminal voltage Vcc descends till reaching the minimum working voltage Voff, and therefore the control integrated circuit CIC turns off, the enable/disable terminal voltage Vref goes to the low level. Afterward, the startup circuit 40 is restarted when the controlled switch is closed (turned on). However, the feeding terminal voltage Vcc is greater than the first prefixed voltage V3 so that the controlled switch 44 stays open and the capacitor Cs charges itself with the only current of the first current generator 41 equal to I. The feeding terminal voltage Vcc rises up and reaches the starting voltage of the control integrated circuit CIC that is the start-up voltage Von, the control integrated circuit CIC starts working, the enable/disable terminal voltage Vref rises up. But there being still the condition of short circuit the feeding terminal voltage Vcc returns to decrease and the phases previously described are repeated until the condition of short circuit has not been eliminated.

Although the (K+1)*I-current flowing from the output terminal OUT can provide a larger charging current to accelerate starting up the system, this needs to use a larger-area integrated circuit and spend more costs to implement.

Furthermore, U.S. Pat. No. 7,525,819 disclosed a switching mode power supply. Reference is made to FIG. 3A and FIG. 3B which are a circuit block diagram of a prior art switching mode power supply and a waveform of a bias voltage and a drain current during the start-up of the switching mode power supply, respectively.

The switching mode power supply includes a power supply 100, an output unit 200, a feedback circuit 300, a switching controller 400, and an auxiliary coil supply unit 500. In particular, the auxiliary coil supply unit 500 has an auxiliary coil L3 of a transformer, a diode D2, and a capacitor C2.

The switching controller 400 has a PWM controller 420, an initial bias voltage supply 440, and a switching MOS transistor Qsw. In particular, the auxiliary coil L3 and the diode D2 are operable to apply a bias voltage Vcc to the capacitor C2 through the initial bias voltage supply 440. Further, the PWM controller 420 outputs a control signal for shutting down the initial bias voltage supply 440 to stopping supplying the capacitor C2.

The PWM controller 420 receives the bias voltage Vcc and a feedback voltage Vfb. As shown in FIG. 3B, the switching MOS transistor Qsw is not conducting (is “OFF”) and the capacitor C2 is charged through the initial bias voltage supply 440 when the power supply is initially energized. Hence, the bias voltage Vcc gradually rises. Afterward, the PWM controller 420 outputs a signal to switch the switching MOS transistor Qsw when the bias voltage Vcc exceeds a reference voltage Vref. Correspondingly, the auxiliary coil supply unit 500 starts operating and a voltage is generated in capacitor C2. After a predetermined time delay Tdelay from turning on the switching MOS transistor Qsw, the PWM controller 420 outputs a signal to shut down the initial bias voltage supply 440. Hence, the capacitor C2 is charged by the auxiliary coil supply unit 500 to provide the required energy to the PWM controller 420. The above-described cycle continuously repeats until power is removed to the switching mode power supply.

During the Initially energizing time, the traditional startup circuit system usually cannot provide sufficient power for required circuits. Hence, a voltage buffer needs to be provided while the system is started up and shut down. In this embodiment, the PWM controller 420 is collectively supplied through a charged voltage of the capacitor and an auxiliary voltage. Beside of the charged voltage and the auxiliary voltage, however, a startup current source is jointed to supply the PWM controller 420, thus the voltage buffer can be reduced. Accordingly, the reference voltage Vref can be designed lower than the second voltage in the above-mentioned U.S. Pat. No. 6,587,357 to early start up the system. However, the technology has the following disadvantages: (1) If the startup current exceeds the required current of the control chip (namely, the PWM controller), the control chip will be damaged or an over-voltage protection needs to be executed to protect the control chip due to the continuously rising source voltage; (2) Because of the reduced voltage buffer and the fixed time delay Tdelay, the PWM controller 420 may not be completely supplied through the charged voltage and the auxiliary voltage after the fixed time delay Tdelay, thus the system could be shut down due to the too low source voltage.

Accordingly, it is desirable to provide a startup control circuit with an acceleration startup function and a method for operating the same. By turning on and turning off an enable switch unit of a startup control apparatus, the acceleration startup control and the stable output power of the power supply can be implemented.

### SUMMARY OF THE INVENTION

In order to solve the above-mentioned problems, a startup control circuit with an acceleration startup function is disclosed. The startup control circuit is applied to a power supply. The startup control circuit is coupled to a primary-side winding of a transformer via a power switch for controlling the transformer to adjust output voltage of the power supply. The startup control circuit includes a capacitor and a startup control apparatus.

The capacitor provides an operation voltage. The startup control apparatus is electrically connected to the capacitor and the power switch. The startup control apparatus includes an enable switch unit and a power control unit. The enable switch unit is electrically connected to the primary-side winding of the transformer and the capacitor. The power control unit is electrically connected to the enable switch unit to receive the operation voltage for controlling the enable switch unit.

After the power supply starts up, the power control unit outputs a low-level enable signal to turn off the enable switch unit when an upper-threshold-voltage operation of the power supply is executed, thus the operation voltage does not increase. In addition, the power control unit outputs a high-level enable signal to turn on the enable switch unit when a lower-threshold-voltage operation of the power supply is executed, thus the operation voltage does not decrease. Furthermore, the power control unit outputs the low-level enable signal to turn off the enable switch unit when a stable operation of the power supply is executed.

In order to solve the above-mentioned problems, a method for operating a startup control circuit with an acceleration startup function is disclosed. The method for operating the startup control circuit is applied to a power supply. The startup control circuit is coupled to a primary-side winding of a transformer via a power switch for controlling the transformer to adjust output voltage of the power supply. The method for operating the startup control circuit includes the following steps: First, a startup operation of the power supply is judged whether to execute or not. Afterward, a control signal is outputted to control a power switch when the startup operation of the power supply is executed. Afterward, an abnormal voltage operation of the power supply is judged whether to execute or not. Afterward, a stable operation of the power supply is judged whether to execute or not when the abnormal voltage operation of the power supply is not executed. Finally, a low-level enable signal is outputted to turn off the enable switch unit when the stable operation of the power supply is executed.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1A is a circuit block diagram of a prior art power converter with a power controller;

FIG. 1B is a waveform associated with the integrated self-supply circuit depicted in FIG. 1A;

FIG. 2A is a circuit block diagram of a prior art power converter with a startup circuit;

FIG. 2B is a waveform of voltages present in some points and of an output current of the circuit in FIG. 2A;

FIG. 3A is a circuit block diagram of a prior art switching mode power supply;

FIG. 3B is a waveform of a bias voltage and a drain current during the start-up of the switching mode power supply;

FIG. 4A is a circuit block diagram of a startup control circuit with an acceleration startup function applied to a power supply according to a preferred embodiment of the present invention;

FIG. 4A′ is a circuit block diagram of a startup control circuit with an acceleration startup function applied to a power supply according to another embodiment of the present invention;

FIG. 4B is an output waveform graph of the startup control circuit;

FIG. 4C is a partial output waveform graph in FIG. 4B; and

FIG. 4D is a flowchart of a method for operating the startup control circuit.

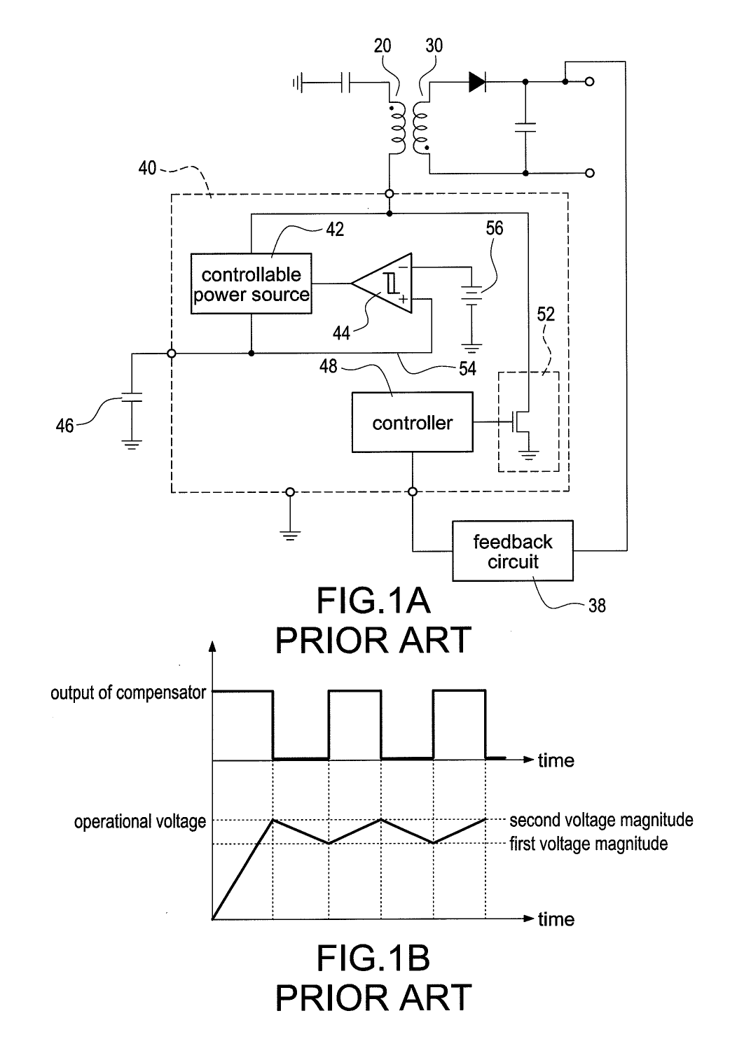

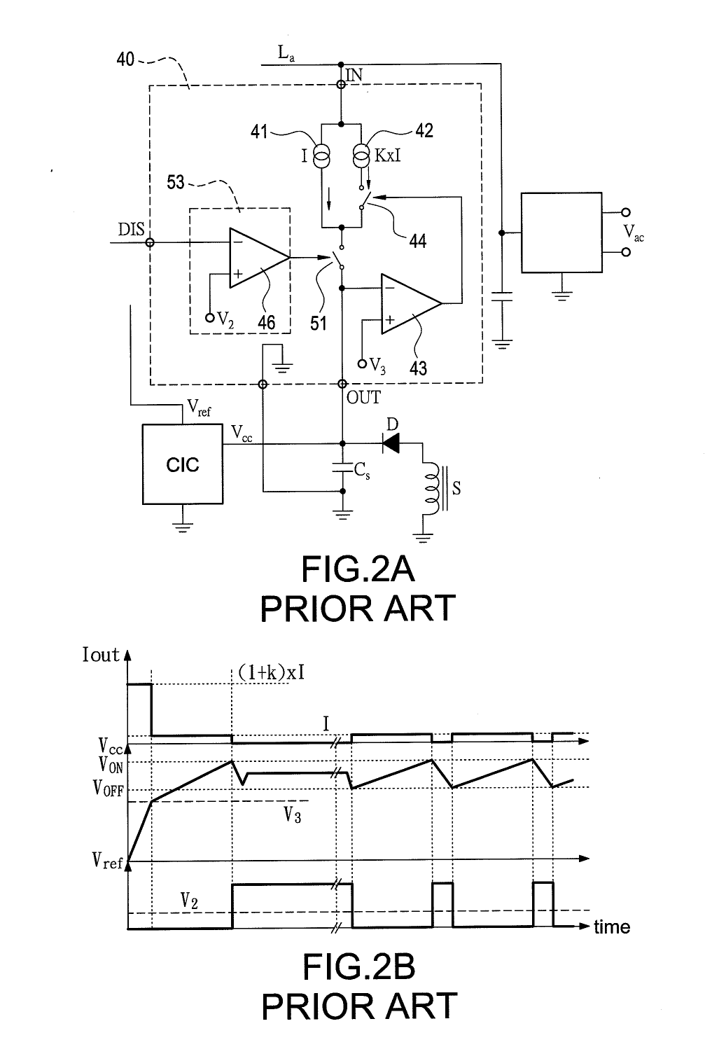

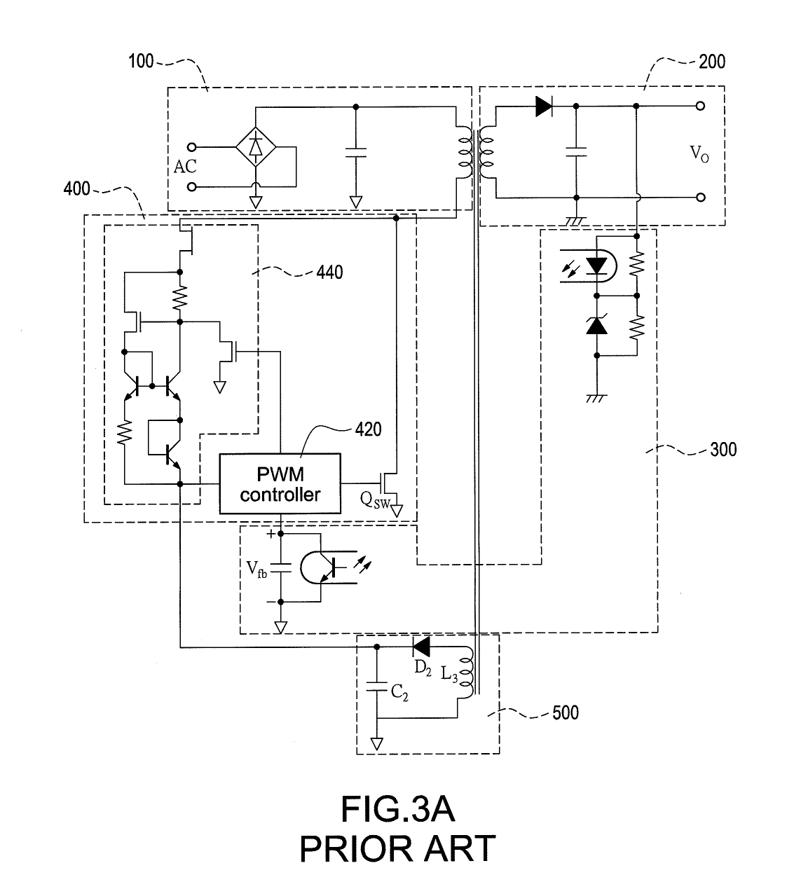

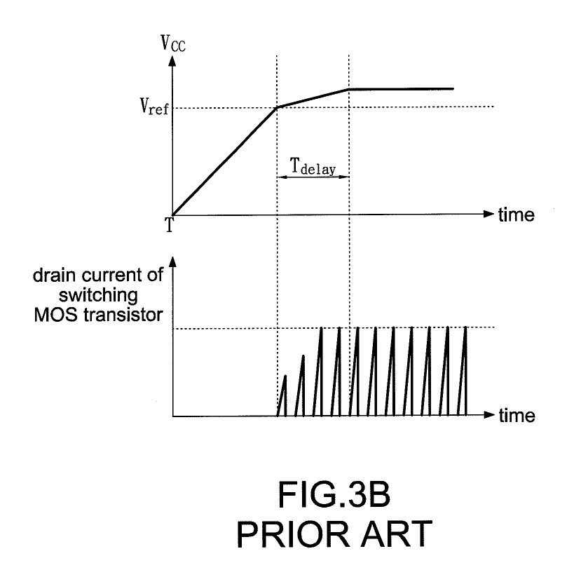

### DETAILED DESCRIPTION OF THE INVENTION

Reference will now be made to the drawing figures to describe the present invention in detail.

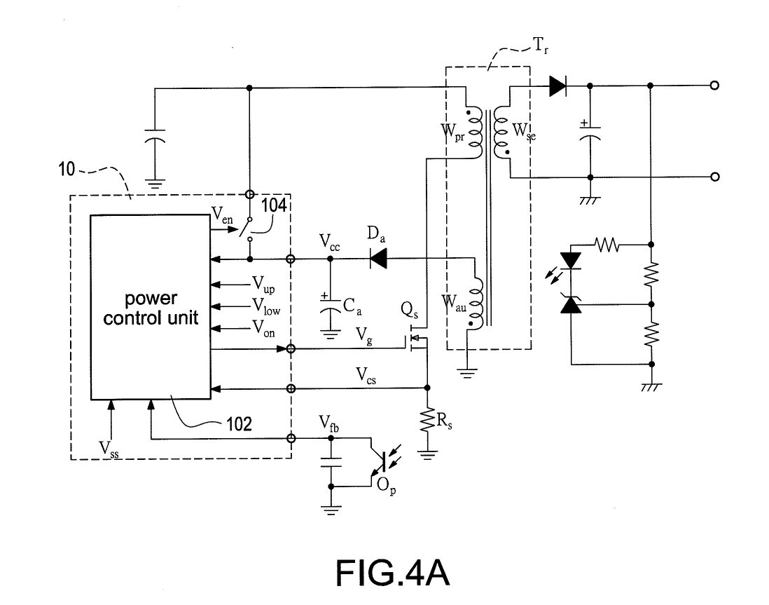

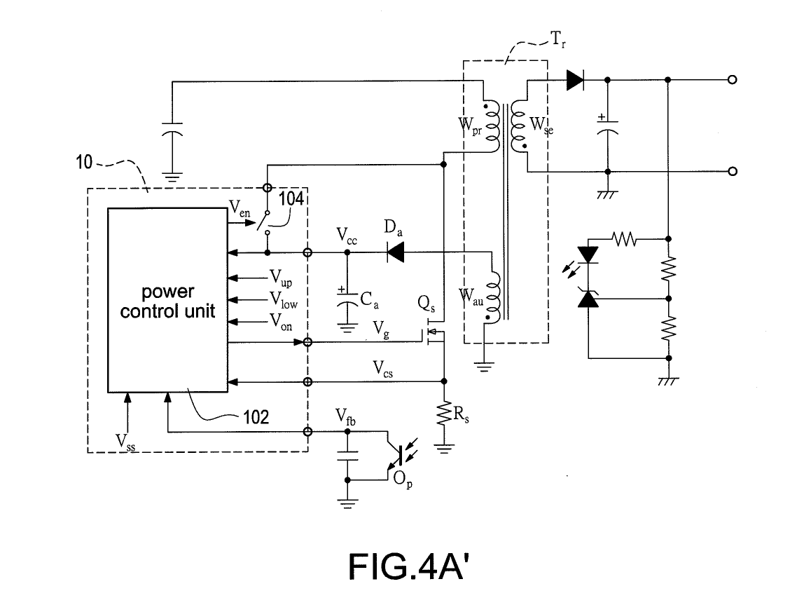

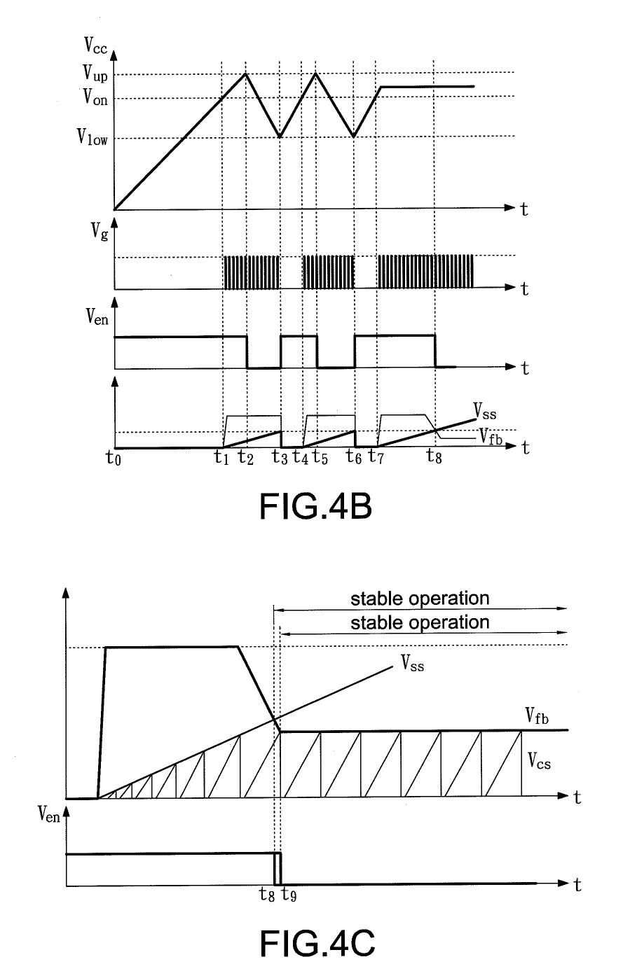

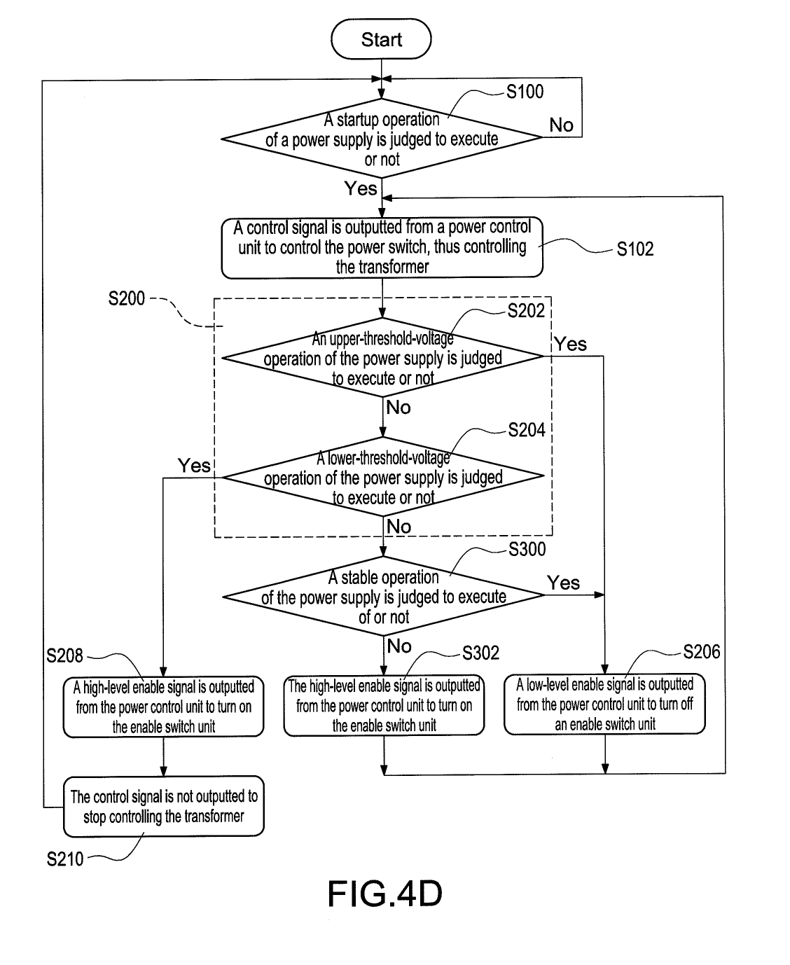

Reference is made to FIG. 4A which is a circuit block diagram of a startup control circuit with an acceleration startup function applied to a power supply according to a preferred embodiment of the present invention. The startup control circuit is applied to a power supply. The startup control circuit is coupled to a primary-side winding Wpr of a transformer Tr via a power switch Qs for controlling the transformer Tr to adjust output voltage of the power supply. The transformer Tr further includes a secondary-side winding Wse and an auxiliary winding Wau.

The startup control circuit includes a capacitor Ca and a startup control apparatus 10. The capacitor Ca is coupled to the auxiliary winding Wau of the transformer Tr through a diode Da to provide an operation voltage Vcc. The startup control apparatus 10 is electrically connected to the primary-side winding Wpr of the transformer Tr, the capacitor Ca, and the power switch Qs.

The startup control apparatus 10 includes an enable switch unit 104 and a power control unit 102. The enable switch unit 104 is electrically connected to the primary-side winding Wpr of the transformer Tr and the capacitor Ca. Especially to deserve to be mentioned, the enable switch unit 104 is not limited only to be electrically connected to a dot end of the primary-side winding Wpr, further can be electrically connected to a non-dot end thereof. As shown in FIG. 4A′ is a circuit block diagram of a startup control circuit with an acceleration startup function applied to a power supply according to another embodiment of the present invention. The power control unit 102 is electrically connected to the enable switch unit 104 to receive the operation voltage Vcc, thus controlling the enable switch unit 104. In particular, the startup control apparatus 10 produces a lower-threshold voltage Vlow, an upper-threshold voltage Vup, a turned-on voltage Von, and a soft start signal Vss to provide the power control unit 102 controlling the enable switch unit 104.

The startup control circuit further includes an optical coupler Op and a sense resistor Rs. The optical coupler Op is electrically connected to the power control unit 102 of the startup control apparatus 10 to produce a feedback signal Vfb, thus providing the power control unit 102 controlling the enable switch unit 104.

The detailed operation of the startup control circuit is described as follows. Reference is made to FIG. 4B which is an output waveform graph of the startup control circuit. The graph of FIG. 4B shows, starting from the top, the operation voltage Vcc, the control signal Vg, the enable signal Ven, and the soft start signal Vss and the feedback signal Vfb. At an initial time t0, the power supply is initially energized. The enable switch unit 104 is turned on by the power control unit 102. Hence, the capacitor Ca is charged to provide the operation voltage Vcc via a fixed current source when the enable switch unit 104 is turned on. Afterward, a startup operation of the power supply is executed and the power control unit 102 outputs a control signal Vg to control the power switch Qs, thus controlling the transformer Tr. That is, the startup operation of the power supply is executed when the charged operation voltage Vcc is greater than the turned-on voltage Von at a first time t1. At this time, the power control unit 102 outputs a control signal Vg to control the power switch Qs, thus controlling the transformer Tr. In particular, the system starts up, the system, however, is not stable yet. Afterward, an upper-threshold-voltage operation of the power supply is executed and the power control unit 102 outputs a low-level enable signal Ven to turn off the enable switch unit 104, thus the operation voltage Vcc does not continue to increase. That is, the upper-threshold-voltage operation of the power supply is executed when the operation voltage Vcc is greater than the upper-threshold voltage Vup at a second time t2. The enable switch unit 104 is turned off to avoid the continuously rising operation voltage Vcc due to the continuously rising supply voltage. Accordingly, the power control unit 102 outputs the low-level enable signal Ven to turn off the enable switch unit 104 when the operation voltage Vcc is greater than the upper-threshold voltage Vup. At this time, the startup control apparatus 10 is collectively supplied through the auxiliary winding Wau of the transformer Tr and the capacitor Ca. It is worth noting that the upper-threshold voltage Vup is only judged to turn off the enable switch unit 104 when the operation voltage Vcc is greater than the upper-threshold voltage Vup, it's really not a judgment for shutting down the startup control apparatus 10 when the startup control apparatus 10 is executed under an abnormal over-voltage operation.

At this time, the capacitor Ca is not charged when the enable switch unit 104 is turned off, thus the operation voltage Vcc gradually decreases. Afterward, a lower-threshold-voltage operation of the power supply is executed and the power control unit 102 outputs a high-level enable signal Ven to turn on the enable switch unit 104 when the lower-threshold-voltage operation of the power supply is executed. That is, the lower-threshold-voltage operation of the power supply is executed when the operation voltage Vcc is less than the lower-threshold voltage Vlow at a third time t3. At this time, the capacitor Ca is charged again so that the operation voltage Vcc does not continue to decrease; on the contrary, the operation voltage Vcc increases. Afterward, at a fourth time t4 (as the first time t1), the startup operation of the power supply is executed again when the operation voltage Vcc is greater than the turned-on voltage Von again. Afterward, at a fifth time t5 (as the second time t2), the upper-threshold-voltage operation of the power supply is executed again when the operation voltage Vcc is greater than the upper-threshold voltage Vup because the capacitor Ca is charged to gradually increase the operation voltage Vcc. At this time, the enable switch unit 104 is turned off and the capacitor Ca is not charged, thus the operation voltage Vcc gradually decreases again. Afterward, at a sixth time t6 (as the third time t3), the lower-threshold-voltage operation of the power supply is executed again when the operation voltage Vcc is less than the lower-threshold voltage Vlow. At this time, the capacitor Ca is charged again so that the operation voltage Vcc does not continue to decrease; on the contrary, the operation voltage Vcc increases. Afterward, at a seventh time t7 (as the fourth time t4 or the first time t1), the startup operation of the power supply is executed again when the operation voltage Vcc is greater than the turned-on voltage Von again.

A normal operation of the power supply is executed when the operation voltage Vcc is not greater than the upper-threshold voltage Vup and the operation voltage Vcc is not less than the lower-threshold voltage Vlow. That is, the he operation voltage Vcc is between the upper-threshold voltage Vup and the lower-threshold voltage Vlow. Reference is made to FIG. 4C which is a partial output waveform graph in FIG. 4B. The graph of FIG. 4B shows, starting from the top, the soft start signal Vss, the feedback signal Vfb, the current-sensing signal Vcs, and the enable signal Ven. According to the above-mentioned description, the feedback signal Vfb would raise to a high-level voltage when the system is not stable yet. At this time, the current-sensing signal Vcs is compared to the soft start signal Vss to implement the pulse width modulation. In particular, the soft start signal Vss is provided to prevent from saturation of the transformer Tr or other problems because the duty cycle of the PWM instantaneously becomes greater when the startup operation of the power supply is executed and the output voltage is not completely built.

The power control unit 102 outputs a low-level enable signal Ven to turn off the enable switch unit 104 when the stable operation of the power supply is executed. The feedback signal Vfb would reduce to a stable signal, namely, the feedback signal Vfb is less than the soft start signal Vss when the system is stably built. That is, the stable operation of the power supply is executed when the feedback signal Vfb downward crosses the soft start signal Vss at an eighth time t8. In particular, the current-sensing signal Vcs is compared to the feedback signal Vfb (instead of the soft start signal Vss) to implement the pulse width modulation. At this time, the power control unit 102 outputs the low-level enable signal Ven to turn off the enable switch unit 104 when the stable operation of the power supply is executed. Accordingly, the startup control apparatus 10 is supplied through the auxiliary winding Wau of the transformer Tr when the system is stable. Furthermore, the stable operation of the power supply can also be judged when the feedback signal Vfb downward crosses the soft start signal Vss and the current-sensing signal Vcs reaches the feedback signal Vfb at a ninth time t9. Similarly, the current-sensing signal Vcs is compared to the feedback signal Vfb (instead of the soft start signal Vss) to implement the pulse width modulation.

Therefore, by turning on and turning off the enable switch unit 104 of the startup control apparatus 10, the acceleration startup control and the stable output power of the power supply can be implemented.

Reference is made to FIG. 4D which is a flowchart of a method for operating the startup control circuit. The method for operating the startup control circuit is applied to a power supply. The startup control circuit is coupled to a primary-side winding of a transformer via a power switch for controlling the transformer to adjust output voltage of the power supply.

The startup control circuit (not shown) includes a capacitor and a startup control apparatus. The capacitor is coupled to an auxiliary winding of the transformer through a diode. The startup control apparatus is electrically connected to the primary-side winding, the capacitor, and the power switch.

The startup control apparatus includes an enable switch unit and a power control unit. The enable switch unit is electrically connected to the primary-side winding of the transformer and the capacitor. The power control unit is electrically connected to the enable switch unit to receive a feedback signal, a current-sensing signal, a soft start signal, an operation voltage, a lower-threshold voltage, an upper-threshold voltage, and a turned-on voltage, thus controlling the enable switch unit. In particular, the lower-threshold voltage, the upper-threshold voltage, the turned-on voltage, and the soft start signal are produced from the startup control apparatus.

The startup control circuit further includes an optical coupler and a sense resistor. The optical coupler is electrically connected to the power control unit of the startup control apparatus to provide the feedback signal. The sense resistor is electrically connected in series to the power switch to provide the current-sensing signal.

The method of operating the startup control circuit includes the following steps: First, a startup operation of the power supply is judged to execute or not (S100). In particular, the startup operation of the power supply is executed when the operation voltage is greater than the turned-on voltage. If the startup operation of the power supply is not executed, the step (S100) is re-executed. On the contrary, a control signal is outputted from a power control unit to control the power switch, thus controlling the transformer (S102) when the startup operation of the power supply is executed. Afterward, an abnormal voltage operation of the power supply is judged to execute or not (S200). In the step (S200), further including the following steps: First, an upper-threshold-voltage operation of the power supply is judged to execute or not (S202). In particular, the upper-threshold-voltage operation of the power supply is executed when the operation voltage is greater than the upper-threshold voltage. At this time, the low-level enable signal is outputted from the power control unit to turn off an enable switch unit (S206). Afterward, the step (S102) is re-executed. On the contrary, a lower-threshold-voltage operation of the power supply is judged to execute or not (S204) if the upper-threshold-voltage operation of the power supply is not executed. In particular, the lower-threshold-voltage operation of the power supply is executed when the operation voltage is less than the lower-threshold voltage. At this time, the high-level enable signal is outputted from the power control unit to turn on the enable switch unit (S208). Afterward, the control signal is not outputted to stop controlling the transformer (S210). Afterward, the step (S100) is re-executed.

Afterward, a stable operation of the power supply is judged to execute or not (S300) when the abnormal voltage operation of the power supply is not executed. That is, the stable operation of the power supply is judged to execute or not (S300) when both the upper-threshold-voltage operation and the lower-threshold-voltage operation of the power supply are not executed. In particular, the stable operation of the power supply is executed when the feedback signal downward crosses the soft start signal. Furthermore, the stable operation of the power supply is executed when the feedback signal downward crosses the soft start signal and the current-sensing signal reaches the feedback signal.

The high-level enable signal is outputted from the power control unit to turn on the enable switch unit (S302) when the stable operation of the power supply is not executed. Afterward, the step (S102) is re-executed.

Finally, the low-level enable signal is outputted from the control unit to turn off the enable switch unit (S206) when the stable operation of the power supply is executed. Afterward, the step (S102) is re-executed.

Therefore, by judging the operation conditions of the power supply, the acceleration startup control and the stable output power of the power supply can be implemented.

In conclusion, the present invention has following advantages:

1. By turning on and turning off the enable switch unit of the startup control apparatus, the acceleration startup control of the power supply can be implemented; and

2. By turning on and turning off the enable switch unit of the startup control apparatus, the stable output power of the power supply can be implemented.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A startup control circuit with an acceleration startup function applied to a power supply, the startup control circuit coupled to a primary-side winding of a transformer via a power switch for controlling the transformer to adjust output voltage of the power supply; the startup control circuit comprising:
a capacitor providing an operation voltage; and
a startup control apparatus electrically connected to the capacitor and the power switch;
the startup control apparatus comprising:
an enable switch unit electrically connected to the primary-side winding of the transformer and the capacitor; and
a power control unit electrically connected to the enable switch unit to receive the operation voltage for controlling the enable switch unit;
after the power supply starting up, the power control unit outputs a low-level enable signal to turn off the enable switch unit when an upper-threshold-voltage operation of the power supply is executed, thus the operation voltage does not increase; in addition, the power control unit outputs a high-level enable signal to turn on the enable switch unit when a lower-threshold-voltage operation of the power supply is executed, thus the operation voltage does not decrease; furthermore, the power control unit outputs the low-level enable signal to turn off the enable switch unit when a stable operation of the power supply is executed.

2. The startup control circuit of claim 1, wherein the startup control circuit further comprising:
an optical coupler electrically connected to the power control unit of the startup control apparatus to produce a feedback signal, thus providing the power control unit to control the enable switch unit; and
a sense resistor electrically connected in series to the power switch to produce a current-sensing signal, thus providing the power control unit to control the enable switch unit.

3. The startup control circuit of claim 1, wherein the startup control apparatus produces a lower-threshold voltage, an upper-threshold voltage, a turned-on voltage, and a soft start signal to provide the power control unit to control the enable switch unit.

4. The startup control circuit of claim 3, wherein the startup operation of the power supply is executed when the operation voltage received by the power control unit is greater than the turned-on voltage received by the power control unit.

5. The startup control circuit of claim 1, wherein the upper-threshold-voltage operation of the power supply is executed when the operation voltage received by the power control unit is greater than the upper-threshold voltage.

6. The startup control circuit of claim 1, wherein the lower-threshold-voltage operation of the power supply is executed when the operation voltage received by the power control unit is less than the lower-threshold voltage.

7. The startup control circuit of claim 1, wherein the stable operation of the power supply is executed when the feedback signal received by the power control unit downward crosses the soft start signal.

8. The startup control circuit of claim 1, wherein the stable operation of the power supply is executed when the feedback signal received by the power control unit downward crosses the soft start signal and the current-sensing signal received by the power control unit reaches the feedback signal.

9. A method for operating a startup control circuit with an acceleration startup function applied to a power supply, the startup control circuit coupled to a primary-side winding of a transformer via a power switch for controlling the transformer to adjust output voltage of the power supply; steps of operating the startup control circuit comprising:
(a) judging whether a startup operation of the power supply is executed or not;
(b) outputting a control signal to control the power switch when the startup operation of the power supply is executed;
(c) judging whether an abnormal voltage operation of the power supply is executed or not;
(d) judging whether a stable operation of the power supply is executed or not when the abnormal voltage operation of the power supply is not executed; and
(e) outputting a low-level enable signal to turn off the enable switch unit when the stable operation of the power supply is executed.

10. The method for operating the startup control circuit of claim 9, the step (c) further comprising:
(c1) judging whether an upper-threshold-voltage operation of the power supply is executed or not; and
(c2) judging whether a lower-threshold-voltage operation of the power supply is executed or not when the upper-threshold-voltage operation of the power supply is not executed.

11. The method for operating the startup control circuit of claim 10, the step (c1) further comprising:
(c11) outputting the low-level enable signal to turn off the enable switch unit when the upper-threshold-voltage operation of the power supply is executed; and
(c12) re-executing the step (b).

12. The method for operating the startup control circuit of claim 10, the step (c2) further comprising:
(c21) outputting the high-level enable signal to turn on the enable switch unit when the lower-threshold-voltage operation of the power supply is executed;
(c22) stopping outputting the control signal to stop controlling the transformer; and
(c23) re-executing the step (a).

13. The method for operating the startup control circuit of claim 9, the step (e) further comprising:
(e1) outputting the high-level enable signal to turn on the enable switch unit when the stable operation of the power supply is not executed; and
(e2) re-executing the step (b).

14. The method for operating the startup control circuit of claim 9, the step (a) further comprising:
(a1) re-executing the step (a) when the startup operation of the power supply is not executed.

15. The method for operating the startup control circuit of claim 9, wherein the startup operation of the power supply is executed when an operation voltage received by a power control unit is greater than a turned-on voltage received by the power control unit.

16. The method for operating the startup control circuit of claim 9, wherein the upper-threshold-voltage operation of the power supply is executed when the operation voltage received by the power control unit is greater than an upper-threshold voltage received by the power control unit.

17. The method for operating the startup control circuit of claim 9, wherein the lower-threshold-voltage operation of the power supply is executed when the operation voltage received by the power control unit is less than a lower-threshold voltage received by the power control unit.

18. The method for operating the startup control circuit of claim 9, wherein the stable operation of the power supply is executed when a feedback signal received by the power control unit downward crosses a soft start signal received by the power control unit.

19. The method for operating the startup control circuit of claim 9, wherein the stable operation of the power supply is executed when the feedback signal received by the power control unit downward crosses the soft start signal and a current-sensing signal received by the power control unit reaches the feedback signal.
